(19) United States
(12) Patent Application Publication
(10) Pub. No.: US 2023/0311774 A1
(43) Pub. Date: Oct. 5, 2023

(54) GUARD RAIL ASSEMBLY AND METHOD OF USE THEREOF

(71) Applicant: EKK Holdings Pty Limited, Paget (AU)

(72) Inventors: Eric Neilsen, Paget (AU); Kodey Charles Neilsen, Paget (AU)

(21) Appl. No.: 18/206,455

(22) Filed: Jun. 6, 2023

Related U.S. Application Data
(63) Continuation-in-part of application No. PCT/AU21/51467, filed on Dec. 8, 2021.

(30) Foreign Application Priority Data
Dec. 9, 2020 (AU) 2020904570
Sep. 21, 2021 (AU) 2021903035
Apr. 24, 2023 (AU) 2023901215

(51) Int. Cl. B60R 3/00

(52) U.S. Cl. CPC B60R 3/005; B60S 5/00

(57) ABSTRACT

A foldable guard rail assembly for a chassis of a vehicle, such as, e.g., mining and excavation vehicles, is provided. In one form, the rail assembly includes at least one guard rail and two or more support members having an upper end pivotally coupled to the at least one guard rail and an opposed lower end pivotally mountable to the chassis such that the two or more support members and the at least one guard rail are configured to be raised and lowered relative to the chassis between a folded position in which the two or more support members and the at least one guard rail are folded relative to the chassis and an operable position in which the two or more support members extend proud from the chassis with the at least one guard rail extending therebetween.

### CROSS-REFERENCE TO RELATED APPLICATIONS

This application is a continuation in part of the US designation of International Application No. PCT/AU2021/051467, filed Dec. 8, 2021, and claiming priority to Australian Provisional Applications No. 2020904570, filed Dec. 9, 2021, No. 2021903035, filed Sep. 21, 2021, and No. 2023901215, filed Apr. 23, 2023, the contents of which are incorporated by reference in their entireties.

### TECHNICAL FIELD

The present invention relates to guard rail assembly for a chassis of a vehicle. In particular, the present invention concerns a guard rail assembly for a chassis of a mining and excavation vehicle when undergoing maintenance.

### BACKGROUND

Modern mining and excavation vehicles are engineered for use in high-production mining and heavy-duty construction environments. Accordingly, such vehicles usually have large vehicle frames, or chassis, in order to support a large payload capacity.

The immense size of the vehicles means that the vehicle chassis pose a serious fall hazard for mechanics or technicians when servicing such vehicles. Consequently, modern occupational health and safety laws typically require that guard rails be temporarily fitted about an upper periphery of the chassis when routine maintenance and/or repair work is being undertaken.

A problem in general with such a requirement is that in order to fit the guard rails a mechanic or technician must first access the upper surface of the chassis and individually handle and fit the guard rails, all while risking his or her own safety. Further, and once the routine maintenance and/or repair work has been undertaken, the same, or another mechanic or technician, must then again access the chassis to remove the temporary guard rails, all while again risking his or her own safety.

A further problem with the requirement and current practice is the time and cost spent in fitting the guard rails before any actual maintenance and repair work can even be undertaken and then removing the guard rails once the work has been completed. Indeed, it will be appreciated that such a practice significantly adds to the overall downtime of the vehicle thereby severely disrupting mine and work site operations at significant cost.

### SUMMARY OF INVENTION

Embodiments of the present invention provide a guard rail assembly and method of use thereof, which may at least partially address one or more of the problems or deficiencies mentioned above or which may provide the public with a useful or commercial choice.

With the foregoing in view, the present invention in one form, resides broadly in a guard rail assembly for a chassis of a vehicle, said assembly including at least one guard rail having a first end pivotally mountable to the chassis and a second end pivotable between raised and lowered position relative to the chassis.

According to a first aspect of the present invention, there is provided a guard rail assembly for a chassis of a vehicle, said assembly including:
at least one guard rail having a first end pivotally mountable to the chassis and a second end pivotable between raised and lowered positions relative to the chassis; and
at least one guide rail for guiding and supporting movement of the at least one guard rail relative to the chassis, said at least one guide rail extending between the at least one guard rail and the chassis and slidably mountable to at least one of the at least one guard rail and the chassis for movement relative thereto.

According to a second aspect of the present invention, there is provided a guard rail assembly for a chassis of a vehicle, said assembly including:
at least one guard rail having a first end pivotally mountable to the chassis and a second end pivotable between raised and lowered positions relative to the chassis; and
at least one guide rail for guiding and supporting movement of the at least one guard rail relative to the chassis, said at least one guide rail extending downwards from the at least one guard rail and slidably mountable to the chassis for movement relative thereto.

According to a third aspect of the present invention, there is provided a guard rail assembly for a chassis of a vehicle, said assembly including:
at least one guard rail having a first end pivotally mountable to the chassis and a second end pivotable between raised and lowered positions relative to the chassis; and
at least one guide rail for guiding and supporting movement of the at least one guard rail relative to the chassis, said at least one guide rail extending upwards from the chassis and slidably mountable to the at least one guard rail for movement relative thereto.

According to a fourth aspect of the present invention, there is provided a guard rail assembly for a chassis of a vehicle, said assembly including:
at least one guard rail having a first end pivotally mountable to the chassis and a second end pivotable between raised and lowered positions relative to the chassis;
at least one support member for moving the at least one guard rail relative to the chassis, said at least one support member pivotally mountable to the chassis and configured to be moveable between a folded position in which the at least one guard rail is in the lowered position and an extended position in which the at least one guard rail is in the raised position; and
at least one sliding member for moving the at least one support member between the folded and extended positions and thereby moving the at least one guard rail relative to the chassis, said at least one sliding member extending between the at least one guard rail and the at least one support member and slidably mountable to the at least one guard rail for movement relative thereto.

According to a fifth aspect of the present invention, there is provided a guard rail assembly for a chassis of a vehicle, said assembly including at least one guard rail and two or more support members having an upper end pivotally coupled to the at least one guard rail and an opposed lower end pivotally mountable to the chassis such that the two or more support members and the at least one guard rail are configured to be raised and lowered relative to the chassis between a folded position in which the two or more support members and the at least one guard rail are folded relative to the chassis and an operable position in which the two or more support members extend proud from the chassis with the at least one guard rail extending therebetween.

According to a sixth aspect of the present invention, there is provided a guard rail assembly for a chassis of a vehicle, said assembly including:
at least one guard rail;
two or more support members for supporting the at least one guard rail relative to the chassis, each of said support members having an upper end pivotally coupled to the at least one guard rail and an opposed lower end pivotally mountable to the chassis;
an actuating mechanism for raising and lowering the two or more support members and the at least one guard rail relative to the chassis between a folded position in which the two or more support members and the at least one guard rail are folded relative to the chassis and an operable position in which the two or more support members extend proud from the chassis with the at least one guard rail extending therebetween; and
a pivot arm extending from a lower end of at least one of the support members for interconnecting the support member with the actuating mechanism.

Advantageously, the present invention provides a guard rail assembly that can be permanently fitted to a chassis of a vehicle and remotely raised to erect a barrier when the vehicle is being serviced thereby complying with occupational health and safety laws without risking the safety of a mechanic or technician. The present invention eliminates the time and cost spent in temporarily fitting guard rails every time a vehicle is serviced and thereby reduces vehicle overall down time. Furthermore, embodiments of the present invention provide a guard rail that moves in a parallel arrangement relative to the chassis and therefore provides a barrier of a uniform height atop the chassis.

As indicated above, the guard rail assembly of the present invention is for use with chassis of vehicles, preferably chassis of mining and excavation vehicles, more preferably haul trucks or rigid dump trucks (e.g., Komatsu™ HD1500). It will therefore be convenient to hereinafter describe the guard rail assembly with reference to this example application as the chassis of a haul truck. However, a person skilled in the art will appreciate that the guard rail assembly is capable of broader applications to the chassis of other mining and/or excavation vehicle types.

Typically, the chassis may be formed from metal and may include a pair of longitudinally extending side frame members joined together by a plurality of transversely extending cross frame members. The frame members may be of tubular or solid construction with a substantially rectangular-shaped cross section. The various frame members may be permanently joined together using conventional welding techniques.

Each longitudinally extending side frame member may include a forward end and an opposed rear end and may extend rearwardly at an angle such that the rear end is elevated relative to the forward end. Typically, the side frame member may extend rearwardly in a linear direction, usually at an angle of between about 5° to about 20° relative to a horizontal plane.

Each longitudinally extending side frame member may include an upper wall, an opposed lower wall and a pair of opposed side walls extending longitudinally between the forward and rear ends. The opposed side walls may include an inner side wall and an opposed outer side wall. The side frame member may further include an inner upper edge between the inner side wall and the upper wall.

In some embodiments, the guard rail assembly may be fitted to an inner side wall of one or both longitudinally extending side frame members of the chassis of a vehicle, such as, e.g., the guard rail assembly of the first to fourth aspects of the present invention.

In other embodiments, the guard rail assembly may be fitted to an outer side wall of one or both longitudinally extending side frame members of the chassis of a vehicle, such as, e.g., the guard rail assembly of the fifth or sixth aspects of the present invention.

The guard rail may be of any suitable size, shape and construction to, in use, function as a barrier, and be pivotable between the raised and lowered positions. The rail may include at least one side wall extending longitudinally between the first and second ends, preferably in a linear direction. The guard rail may be of folded, tubular or solid construction and made of metal, preferably steel.

The guard rail may have any suitable cross sectional shape. For example, the guard rail may have a substantially circular, oval-shaped, triangular or rectangular cross-section. The guard rail may be of unitary construction or may be formed from two or more rail pieces, preferably the former, although two or more rail pieces arranged in a telescopic arrangement is also envisaged.

In some embodiments, the guard rail may have a substantially circular cross sectional shape with a single side wall extending longitudinally between the first and second ends.

In other embodiments, the guard rail may have an inverted U cross sectional shape. For example, the guard rail may include a top wall and a pair of opposed sidewalls extending longitudinally between the first and second ends. The opposed sidewalls may extend downwardly from opposed longitudinal edges of the top wall.

The guard rail may extend forward (i.e., towards the front end of the vehicle) from the first end to the second end. The guard rail may be of any suitable length to extend at least partially along a length of the chassis, preferably an entire exposed length of the chassis that may pose a fall hazard.

In some embodiments, the first end of the guard rail may be pivotally mountable to the chassis in any suitable way that allows the guard rail to pivot about the first end and the second end to be pivotable between the raised and lowered positions.

Likewise, the first end of the guard rail may be mountable to any suitable part of the chassis. For example, the first end of the guard rail may be directly or indirectly pivotally mountable to the chassis, preferably indirectly via a guard rail mount.

In some such embodiments, the first end of the guard rail may be pivotally mountable to a suitable location along one of the longitudinally extending side frame members of the chassis, preferably to the inner side wall at a location at or near the rear end, more preferably to the inner side wall at a location at or near the rear end and the inner upper edge.

The first end of the guard rail may have a bearing located at or near the first end. The bearing may include a polymer bushing, preferably a high-density polyethylene (HDPE) bushing.

The guard rail mount may be of any suitable size, shape and construction, and may be connectable to a longitudinally extending side frame member in any suitable way. Preferably, the guard rail mount may include a bracket connectable to the inner side wall of the longitudinally extending side frame member and a pivot pin for pinning the bearing at the first end of the guard rail to the bracket.

The bracket may be connectable to the inner wall of the longitudinally extending side frame member with one or more mechanical fasteners and/or using conventional welding techniques.

In use, when the guard rail is in the raised position, the second end of the guard rail may be pivoted upwards relative to the chassis such that the guard rail may at least partially function as a barrier to prevent a worker from falling over the outer upper edge of a longitudinally extending side frame member of the chassis to which it is pivotally mounted.

The second end of the guard rail may pivot to any suitable height above the chassis when in the raised position to function as a barrier. For example, the second end of the guard rail may pivot to a height of about 1,000 mm, about 1,050 mm, about 1,100 mm, about 1,150 mm, about 1,200 mm, about 1,250 mm, about 1,300 mm, about 1,350 mm, about 1,400 mm, about 1,450 mm, about 1,500 mm, about 1,550 mm, about 1.600 mm, about 1,650 mm, about 1,700 mm, about 1,750 mm, about 1,800 mm, about 1,850 mm, about 1,900 mm, about 1,950 mm, or even about 2,000 mm or higher as measured along a vertical axis extending from the upper surface of the chassis to the second end of the guard rail.

Likewise, the guard rail may be pivoted to any suitable angle relative to the chassis when in the raised position. For example, the guard rail may be pivoted to an angle of about 5°, about 6°, about 7°, about 8°, about 9°, about 10°, about 11°, about 12°, about 13°, about 14°, about 15°, about 16°, about 17°, about 18°, about 19° or about 20° relative to an angle of a longitudinally extending side frame member of the chassis, when in the raised position. Preferably, the guard rail may be pivoted to an angle at which the guard rail has a substantially horizontal orientation when in the raised position.

Conversely, when the guard rail is in the lowered position, the guard rail may extend at least partially along the inner wall of the longitudinally extending side frame member of the chassis to which it is pivotally mounted, preferably in a substantially parallel arrangement. Advantageously, in the lowered position, the guard rail may not interfere with any normal operations of the vehicle thereby allowing the guard rail assembly of the present invention to remain permanently fitted to the vehicle for subsequent uses.

The at least one guide rail may be of any suitable size, shape and construction to, in use, guide and support movement of the at least one guard rail relative to the chassis. Typically, as with the guard rail, the at least one guide rail may be an elongate structure extending longitudinally between a pair of opposed ends, including a chassis connecting end and a guard rail connecting end. The guide rail may be of tubular or solid construction and made of metal, preferably steel. The guide rail may be of unitary construction or may be formed from two or more guide rail pieces, preferably the former.

In some embodiments, the at least one guide rail may extend in a linear direction between the opposed ends.

In other embodiments, the at least one guide rail may extend in an arc between the opposed ends.

As indicated, the at least one guide rail may extend between the at least one guard rail and the chassis and be slidably mounted to any one of the guard rail and the chassis so as to enable movement of the guard rail relative to the chassis.

For example, in some embodiments the guide rail may be slidably mounted to both the guard rail and the chassis, preferably the inner side wall of a longitudinally extending side frame member of the chassis.

In other embodiments, the guide rail may extend downwards from the guard rail and be slidably mountable to the chassis, preferably the inner side wall of a longitudinally extending side frame member of the chassis.

In some such embodiments, the guide rail may be pivotally mountable to the guard rail. The guide rail may be pivotally mountable in any suitable way. Usually, the guide rail may include a bearing at the guard rail connecting end configured to be pinned to an opening in a side wall of the guard rail by a pivot pin, for example.

In other such embodiments, the guide rail may be joined to the guard rail, preferably to the at least one side wall of the guard rail. The guide rail may be joined to the side wall of the guard rail using conventional welding techniques.

In yet other embodiments, the guide rail may extend upwards from the chassis and may be slidably mountable to the guard rail. In such embodiments, the guide rail may be pivotally mountable to the chassis, preferably the inner side wall of a longitudinally extending side frame member of the chassis.

The guide rail and at least one of the guard rail and the chassis may be slidably mountable together in any suitable way.

For example, in some embodiments, the at least one guide rail may include at least one groove extending longitudinally at least partially between the opposed ends and at least one of the guard rail and the chassis may include a slide mount connectable to the at least one of the guard rail and the chassis and configured to be slidable within and along a length of the at least one groove of the at least one guide rail.

The slide mount may be of any suitable size, shape and construction and may be connectable to the at least one of the guard rail and the chassis in any suitable way.

The slide mount may include a bracket connectable to the guard rail or chassis, a shank extending away from the bracket and configured to have the at least one groove of the guide rail mounted thereon, and either an enlarged head or fastener for securing the guide rail relative to the slide mount.

The bracket may be connectable to the at least one side wall of the guard rail or the inner side wall of the longitudinally extending side frame member of the chassis with one or more mechanical fasteners and/or using conventional welding techniques.

In embodiments in which the slide mount includes an enlarged head, the enlarged head may be fastened to, or extend from, the outer end of the shaft, and may be sized and shaped such that it may not pass through the groove so as to secure the guide rail relative to the slide mount.

In embodiments in which the slide mount includes a fastener, the fastener may be configured to be fastened relative to the shank and may be sized and shaped such that it may not pass through the groove so as to secure the guide rail relative to the slide mount. The fastener may preferably include a nut. The shank may preferably include at least a threaded outer portion and the fastener may be threadingly fastened to the shank.

In some embodiments, the slide mount may further include one or more bearings, such as, e.g., a flat bearing or washer bearing. The one or more bearings may include a polymer washer, preferably a high-density polyethylene (HDPE) washer.

In other embodiments, the at least one guide rail may include at least one rail extending longitudinally at least partially between the opposed ends and at least one of the guard rail and the chassis may include a slide mount as previously described and configured to be slid along a length of the rail.

The at least one rail may include any form of guided or directional conveyance. For example, the rail may include a track or channel. The rail may be of any suitable size, shape and construction that allows the at least one slide mount to be slid along the rail but prevents lateral movement or separation of the slide mount away from the rail.

In some such embodiments, the rail may include a female formation in the form of an elongate channel defined on the guide rail. The channel may have a C- or U-shaped cross section. In such embodiments, the enlarged head of the slide mount may be in the form of a male formation configured to engage and be retained within the elongate channel and be slidably moveable relative to the elongate channel. In such embodiments, the enlarged head may include, or be in the form of, a roller.

The at least one guide rail may extend between the guard rail and the chassis at any suitable location along a length of the guard rail.

For example, in some embodiments, the at least one guide rail may be located at or near the second end of the guard rail.

Conversely, in other embodiments, the at least one guide rail may be located at a location between the first and second ends of the guard rail.

In some embodiments, the guard rail assembly may include more than one guide rail extending between the guard rail and the chassis. For example, the assembly may include two, three, four, five or six or more guide rails extending between the guard rail and the chassis. Of course, a person skilled in the art will appreciate that the number of guide rails may directly depend on a length of the guard rail.

In such embodiments, the two or more guide rails may be arranged in a spaced arrangement along a length of the guard rail, preferably evenly spaced from one another.

Further, it is to be appreciated that since the guard rail pivots about the first end and the second end pivots between the raised and lowered position, the guide rails extending between the guard rail and the chassis may be of differing lengths as they extend between the first and second ends of the guard rail. Generally, shorter guide rails may extend between the guard rail and the chassis at or near the first end as they provide respective grooves or rails with a shorter length of travel than longer guide rails, which may extend between the guard rail and the chassis at or near the opposed second end.

As indicated, in some embodiments the assembly may include at least one support member for moving the at least one guard rail relative to the chassis, preferably for pivoting the second end of the guard rail between the raised and lowered positions.

In some embodiments, the at least one support member may be of any suitable size, shape and construction to, in use, be moveable between a folded position in which the at least one guard rail is in the lowered position and an extended position in which the at least one guard rail is in the raised position.

Typically, as with the guard rail, the at least one support member may be an elongate structure extending longitudinally between chassis and the at least one guard rail. The support member include a pair of opposed ends, including a chassis connecting end and a guard rail connecting end.

The support member may be of folded, tubular or solid construction and may be made of metal, preferably steel. The support member may be of unitary construction or may be formed from two or more support member pieces.

The chassis connecting end may preferably be pivotally mountable to the chassis such that the at least one support member may be pivotable about the chassis connecting end between the folded and extended positions.

The chassis connecting end may be mountable to any suitable part of the chassis. For example, the chassis connecting end may be directly or indirectly pivotally mountable to the chassis, preferably indirectly via a support member mount.

In some embodiments, the guard rail connecting end of the at least one support member may be slidably mounted to the at least one guard rail.

In such embodiments, the at least one guard rail may be pivotable between the lowered and raised positions by movement of the at least one support member between the folded and extended positions, respectively.

In the folded position, the at least one support member may pivot alongside the chassis causing the guard rail connecting end to slide towards the first end of the guard rail and pivot the second end of the at least one guard rail to the lowered position.

In the extended position, the chassis connecting end may pivot relative to the chassis to a substantially upright orientation thereby causing the guard rail connecting end to slide towards the second end of the guard rail and pivot the second end of the guard rail to the raised position.

The at least one support member and the guard rail may be slidably mountable together in any suitable way.

For example, in some such embodiments, the at least one guard rail may define an inverted U-shaped groove extending at least partially between the opposed ends and the guard rail connecting end of the support member may include a slide mount connectable to the at least one guard rail and configured to be slidable within and along a length of the at least one guard rail.

The slide mount may be as previously described.

In other embodiments, the guard rail connecting end of the at least one support member may be pivotally mountable to the at least one guard rail, preferably at or near the second end of the guard rail.

In such embodiments, the support member may include a two or more support member portions pivotally coupled together and moveable between the folded position in which the portions fold relative to one another alongside the chassis causing the second end of the guard rail to pivot to the lowered position and the extended position in which the portions align thereby causing the support member to extend in a substantially upright orientation relative to the chassis and the second end of the guard rail to pivot to the raised position.

The two or more support member portions may be pivotally coupled together in any suitable way as previously described.

In other embodiments, the at least one guard rail may be supported relative to the chassis by the two or more support members and may be moveable relative to the chassis between the operable and folded positions, preferable in a substantially parallel arrangement relative to the chassis.

Generally, the at least one guard rail may be of any suitable length to extend at least partially along the chassis, preferably an entire exposed length of the chassis that may pose a fall hazard.

The two or more support members may be of any suitable size, shape and construction to, in use, support the at least one guard rail relative to the chassis, and be raised and lowered relative to the chassis between the folded and operable positions while having the at least one guard rail extend therebetween. Typically, the two or more support members may be of the same size and shape.

Each support member may include a pair of opposed ends and an elongate body extending therebetween, preferably in a linear orientation. The opposed ends may include the upper end and the opposed lower end.

The elongate body may be defined by at least one sidewall extending between the opposed ends.

The support member may be of folded, tubular or solid construction and made of metal, preferably steel.

The support member may have any suitable cross sectional shape. For example, the support member may have a substantially circular, oval-shaped, triangular or rectangular cross-section. The support member may be of unitary construction or may be formed from two or more member pieces, preferably the former, although two or more member pieces arranged in a telescopic arrangement is also envisaged so as to provide a height adjustable guard rail assembly.

In some embodiments, the support member may have a substantially circular cross sectional shape with a single side wall extending longitudinally between the opposed ends.

In other embodiments, the support member may have a substantially U-shaped cross sectional shape.

In some such embodiments, the at least one guard rail and the two or more support members are pivotally coupled together in any suitable way so that they are together moveable between the folded and operable positions.

The upper end of the support member and the guard rail may be directly or indirectly coupled.

For example, in some embodiments, the guard rail and the support member may be pivotally coupled by way of a bracket or the like.

In some such embodiments, the bracket may be connectable to mounting points defined on one or both of the support member and the guard rail.

In other such embodiments, the bracket may be an inverted U-bracket extending down from an underside of the guard rail and configured to sit atop the support member and be connected thereto by way of a pivot pin extending through the upper end of the support member.

In other embodiments, the guard rail and the upper end of the support member may include intermeshing lugs each having a central bore therethrough and configured to be pinned together by at least one pivot pin received through the co-aligned central bores. The guard rail and the support member may be pivot relative to each other about a longitudinal axis of the at least one pivot pin.

In some such embodiments, one of the guard rail and the support member may include a pair of opposed lugs and the other of the guard rail and the support member may include a single lug configured to be received between the pair of opposed lugs and be pinned together by the at least one pivot pin.

In other such embodiments, each of the guard rail and the support member may include a pair of opposed lugs configured to intermesh with each other and be pinned together with at least one pivot pin.

In some embodiments, the assembly may include more than one guard rail. For example, the assembly may include two, three or even four guard rails supported relative to the chassis by the two or more support members, preferably two guard rails.

In some such embodiments, the assembly may include two guard rails supported relative to the chassis by two or more support members. The two guard rails may include a top guard rail pivotally coupled to the upper end of each support member as previously described and a lower guard rail pivotally coupled about midway along a length of each support member.

The lower guard rail and the support members may be pivotally coupled together in any suitable way as previously described. For example, in some embodiments, the lower guard rail may be pinned to a side of a support member with at least one pivot pin.

As indicated, the two or more support members may be pivotally mounted at their respective lower ends to the chassis. The support members may be pivotally mountable in any suitable way so as to be pivotable about the lower end and such that the upper end is pivotable between the folded and operable positions.

The upper end of each support member may pivot about any range of movement between the operable and folded positions, or relative to the chassis. For example, the upper end may pivot about 45°, about 50°, about 55°, about 60°, about 65°, about 70°, about 75°, about 80°, about 85°, about 90°, about 95°, about 100°, about 105°, about 110°, about 115° or even about 120° from a substantially vertical orientation when in the operable position.

In some embodiments, the lower ends of the two or more support members and the chassis may be hingedly coupled together by at least one hinge or part thereof such that the support members are pivotable relative to the chassis, preferably about an axes of the hinges.

In other embodiments, the chassis may include at least one protruding lug having a central bore therethrough configured to intermesh with at least two protruding connecting members have central bores therethrough protruding from the lower end of the two or more support members and be pinned together by a pivot pin received through the co-aligned bores. In such embodiments, the support members may pivot relative to the chassis about the axes of the pivot pins.

In yet other embodiments, the lower end of each support member may include a bearing and the chassis may include a corresponding pair of outwardly protruding mounting plates to which the bearing is pinned with a pivot pin. Again, in such embodiments, the support members may pivot relative to the chassis about the axes of the pivot pins.

In preferred embodiments, the lower end of each support member may include a bore defined thereon and configured to receive a pivot pin therethrough for pivoting the lower end to the chassis, preferably a rail or like structural member associated with the chassis.

As indicated, in some embodiments the assembly may include at least one sliding member for moving the at least one support member between the folded and extended positions and thereby moving the guard rail relative to the chassis, preferably for pivoting the second end of the guard rail between the raised and lowered positions.

The at least one sliding member may be of any suitable size, shape and construction to, in use, extend between the at least one guard rail and the at least one support member and be slidably mountable to the at least one guard rail for movement relative thereto.

Typically, as with the guard rail, the at least one sliding member may be an elongate structure extending longitudinally between the at least one guard rail and the at least one support member. The sliding member include a pair of opposed ends, including a guard rail sliding end and a support member connecting end.

The sliding member may be of folded, tubular or solid construction and may be made of metal, preferably steel. The sliding member may be of unitary construction or may be formed from two or more sliding member pieces.

The at least one sliding member and the guard rail may be slidably mountable together in any suitable way.

For example, in some such embodiments, the at least one guard rail may define an inverted U-shaped groove extending at least partially between the opposed ends and the guard rail sliding end of the sliding member may include a slide mount connectable to the at least one guard rail and configured to be slidable within and along a length of the at least one guard rail.

The slide mount may be as previously described.

The support member connecting end may preferably be pivotally mountable to the support member so as to pivot the support member between the folded and extended position when the sliding member slides at least partially along the guard rail.

The support member connecting end may be mountable to any suitable part of the support member.

Typically, the support member connecting end may be pivotally mountable between the opposed ends of the support member, preferably midway along.

In embodiments in which the support member includes two or more support member portions pivotally coupled together, the support member connecting end may be pivotally mountable to a lower end of an uppermost support member portion so as to cause the portions to fold relative to one another when the sliding member slides at least partially along the guard rail, preferably towards the first end.

In some embodiments, the assembly may include an actuating mechanism for raising and lowering the at least one guard rail. Any suitable type of actuating mechanism may be used.

The actuating mechanism may be manually actuated or by using a drive. Movement may be linear, although non-linear movement such as rotary movement is also envisaged.

For example, if manually actuated, the actuating mechanism may include one or more of a lever, a ram, an operable handle, a cable and pulley arrangement, a cable and winch arrangement, a hinged arrangement or a pivoting arrangement for raising and lowering the guard rail.

The actuating mechanism may include one or more biasing mechanisms.

In some embodiments, movement of the guard rail to the raised position may work against a force of the biasing mechanism and so that the guard rail moves to the lowered position under the force of the biasing mechanism.

Conversely, in other embodiments, movement of the guard rail to the raised position may work under the force of the biasing mechanism and movement of the guard rail to the lowered position may work against the force of the biasing mechanism.

The biasing mechanism may include one or more weights or springs, such as, coil springs, for example. Of course, a person skilled in the art will appreciate that other types of biasing mechanisms, such as, e.g., magnets, electromagnets or magnetized elements and the like may be used.

If using a drive, the drive may be a hydraulic or pneumatic ram, or an electric motor for raising and lowering the guard rail.

In some embodiments, the actuating mechanism may include one or more linear actuators each extending between the chassis and the guard rail and capable of moving between an extended position and a retracted position. The extended and retracted positions may correspond with the raised and lowered positions of the guard rail relative to the chassis, respectively.

The one or more linear actuators may include a pneumatic ram, a hydraulic ram or a rigid chain actuator (also known as a linear chain actuator, a push-pull actuator, an electric chain actuator, a zip chain actuator or a column forming chain actuator).

In other embodiments, the actuating mechanism may be a servomotor or stepper motor configured to pivot the guard rail between the raised and lowered positions.

In yet other embodiments, the actuating mechanism may be a manually, pneumatically or electrically powered screw jack or screw motor.

In yet other embodiments, the actuator or actuating mechanism may include a drive motor, such as, e.g., an electric motor or combustion engine, operatively associated with a winch, a cable and at least one pulley.

In some preferred embodiments, the actuating mechanism may be in the form of a pneumatic ram that may be extend between the guard rail and the chassis for pivoting the guard rail between the raised and lowered positions.

The actuating mechanism may be pivotally coupled to each of the guard rail and the chassis for pivoting the guard rail. The actuating mechanism may preferably be pivotally coupled to each of the at least one side wall of the guard rail and the inner side wall of the longitudinally extending side frame of the chassis by mounting brackets respectively located on each.

The actuating mechanism may be located at any suitable location along the guard rail. Typically, however, the actuating mechanism may extend between the guard rail and the chassis at a location at or near the first end.

The mounting brackets may be connectable to the at least one side wall of the guard rail or the inner side wall of the longitudinally extending side frame member of the chassis with one or more mechanical fasteners and/or using conventional welding techniques.

The actuating mechanism may be pivotally coupled to each mounting bracket in any suitable way. Usually, the actuating mechanism may include a bearing at each end configured to be pinned to an opening in a respective mounting bracket by a pivot pin, for example.

In other preferred embodiments in which the assembly further includes at least one support member and at least one sliding member, the actuating mechanism may be in the form of a pneumatic ram that may be extend between the chassis and the at least one sliding member for sliding the sliding member at least partially along the at least one guard rail and causing the at least one support member to pivot between the folded and extended positions and the guard rail to thereby pivot between the lowered and raised positions, respectively.

The actuating mechanism may be pivotally coupled to each of the chassis and the guard rail sliding end of the sliding member for sliding the sliding member at least partially along the guard rail. The actuating mechanism may preferably be pivotally coupled to each of the guard rail sliding end and the inner side wall of the longitudinally extending side frame of the chassis by mounting brackets respectively located on each.

The actuating mechanism may be located at any suitable location along the guard rail. Typically, however, the actuating mechanism may extend between the chassis and the sliding member at a location at or near the first end.

The mounting brackets may be connectable to the guard rail sliding end of the sliding member and the inner side wall of the longitudinally extending side frame member of the chassis with one or more mechanical fasteners and/or using conventional welding techniques.

The actuating mechanism may be pivotally coupled to each mounting bracket in any suitable way. Usually, the actuating mechanism may include a bearing at each end configured to be pinned to an opening in a respective mounting bracket by a pivot pin, for example.

In some embodiments, the at least one guide rail may include a locking mechanism for locking the at least one guard rail in the raised position. The locking mechanism may be of any suitable size, shape and construction and may be operatively associated with one or more of the at least one guard rail, the at least one guide rail, the slide mount(s) and the chassis.

For example, in some such embodiments, the slide mount(s) may include one or more retention pins or bolts configured to be received in one or more corresponding openings defined in the guide rail for retaining the at least one guard rail in the raised position relative to the chassis.

The one or more corresponding openings may be defined at or near an end of the groove or rail of the at least one guide rail.

The one or more pins or bolts may be spring-loaded pins or bolts, for example.

In some embodiments, the assembly includes an actuating mechanism for raising and lowering the two or more support members and the at least one guard rail relative to the chassis between the folded position and the operable position. Any suitable type of actuating mechanism may be used.

The actuating mechanism may be manually actuated or by using a drive. Movement may be linear, although non-linear movement such as, e.g., rotary movement, is also envisaged.

For example, if manually actuated, the actuating mechanism may include one or more of a lever, a ram, an operable handle, a cable and pulley arrangement, a cable and winch arrangement, a hinged arrangement, or a pivoting arrangement for pivoting the two or more support members and the at least one guard rail relative to the chassis between the folded position and the operable position.

The actuating mechanism may include one or more biasing mechanisms.

For example, in some embodiments movement of the two or more support members and the at least one guard rail relative to the chassis to the operable position may work under a force of the biasing mechanism and movement to the folded position may work against the force of the biasing mechanism.

Conversely, in other embodiments, movement of the two or more support members and the at least one guard rail relative to the chassis to the operable position may work against the force of the biasing mechanism and movement to the folded position may work under the force of the biasing mechanism.

The biasing mechanism may include one or more weights or springs, such as, e.g., coil springs.

If using a drive, the drive may be a hydraulic or pneumatic ram, or an electric motor for raising and lowering the two or more support members and the at least one guard rail relative to the chassis.

In some embodiments, the actuating mechanism may include one or more linear actuators each capable of moving between an extended position and a retracted position.

The one or more linear actuators may include a pneumatic ram, a hydraulic ram or a rigid chain actuator (also known as a linear chain actuator, a push-pull actuator, an electric chain actuator, a zip chain actuator or a column forming chain actuator).

In other embodiments, the actuating mechanism may be a servomotor or stepper motor configured to pivot the two or more support members and the at least one guard rail relative to the chassis between the folded position and the operable position.

In yet other embodiments, the actuating mechanism may be a manually, pneumatically or electrically powered screw jack or screw motor.

In yet other embodiments, the actuator or actuating mechanism may include a drive motor, such as, e.g., an electric motor or combustion engine, operatively associated with a winch, a cable and at least one pulley.

As indicated, at least one of the support members further includes a pivot arm extending downwardly from a lower end for interconnecting with the actuating mechanism.

The pivot arm may be of any suitable size, shape and construction and may be formed from any suitable material or materials.

The pivot arm may include a pair of opposed ends and an elongate body extending therebetween, preferably in an angled orientation, more preferably an L-shaped orientation. The opposed ends may include a proximal end fixedly connected to the lower end of the support member and an opposed distal end configured to interconnect with the actuating mechanism.

The elongate body may be defined by at least one sidewall extending between the opposed ends.

The pivot arm may be of folded, tubular or solid construction and made of metal, preferably steel.

In some embodiments, the pivot arm may have a proximal end portion and a distal end portion orthogonally arranged relative to the proximal end portion, said proximal end portion being configured to be pivotally coupled to the actuating mechanism, preferably a linear actuator.

The pivot arm may extend downwardly from the lower end of a support member and alongside a portion of the chassis.

In some embodiments, the pivot arm may be arranged in an offset arrangement with the lower end of the support member so that it may extend alongside the chassis.

In other embodiments, the pivot arm may extend through an opening defined in a rail or structural member of the chassis, preferably an elongate opening.

In use, the pivot arm may pivot about the proximal end together with the support member and the distal end may be pivotal towards and away from the actuating mechanism to raise and lower the support members (and the at least one guard rail) between the operable and folded positions.

In preferred embodiments, the actuating mechanism may include a linear actuator located beneath the assembly and configured to move between extended and retracted positions to pivot the pivot arm and thus at least one of the support members (together with the at least one guard rail and the other support members) between the operable and folded positions.

The linear actuator may be pivotally coupled to each of the pivot arm and the chassis for pivoting the pivot arm.

In some embodiments, such as with the assembly of any one of the first to fourth aspects, the actuating mechanism may preferably be pivotally coupled to an inner side wall of a longitudinally extending side frame of the chassis, or a rail mounted thereon, by a mounting bracket located thereon.

In other embodiments, such as with the assembly of the fifth or sixth aspects, the actuating mechanism may preferably be pivotally coupled to an outer side wall of a longitudinally extending side frame of the chassis, or a rail mounted thereon, by a mounting bracket located thereon.

The actuating mechanism may be pivotally coupled to each of the pivot arm and the mounting bracket in any suitable way. Usually, the actuating mechanism may include a bearing at each end configured to be pinned to an opening in the pivot arm and the mounting bracket, respectively, by a pivot pin, for example.

In some embodiments in which the assembly includes two or more discrete guard rails, the assembly may include more than one pivot arms. For example, the assembly may include two or more pivot arms mechanically linked together so that movement of one pivot arm by an associated linear actuator may drive movement of the other pivot arm. Advantageously, such embodiments may facilitate synchronized movement of the two or more discrete guard rails.

In some embodiments, the assembly further includes a chassis mount for mounting the assembly to the chassis, typically to the inner upper edge or the outer upper edge. The chassis mount may include an edge rail configured to fit over one of the inner upper edge or the outer upper edge and one or more mounting brackets for mounting the edge rail to the respective edge of the chassis. The two or more support members may be pivotally mounted to the edge rail. Suitably, the actuating mechanism may be mounted at one end to a bracket suspended from an underside of the edge rail and at an opposite end to the pivot arm.

In preferred such embodiments, a proximal end of the pivot arm may extend through an elongate opening defined in the edge rail for connecting to the lower end of at least one of the two or more support members.

In some embodiments, the assembly may include a controller for controlling operation of the actuating mechanism and thus movement of the at least one guard rail relative to the chassis and/or movement of the two or more support members and the at least one guard rail relative to the chassis. The controller may be of any suitable size, shape and configuration.

The controller may be a remote controller or may be associated with the assembly and/or the chassis.

For example, in some embodiments, the controller may be in the form of one or more buttons, switches or dials located on the assembly or the chassis. The one or more buttons, switches or dials may be electrically connected to the actuating mechanism.

In other embodiments, the controller may be a remote controller configured to be held by a user. The remote controller may be a wired or a wireless remote controller. The remote controller may include one or more keys, buttons, switches or dials for controller various aspects of functionality of the assembly, including the actuating mechanism. In some such embodiments, the remote controller may further include a display for displaying operating information of the assembly, such as, e.g., a current position of the at least one guard rail.

According to a seventh aspect of the present invention, there is provided a method of erecting a guard rail on a chassis of a vehicle, said method including:
fitting the guard rail assembly of any one of the first to fourth aspects to the chassis of the vehicle; and
pivoting the at least one guard rail from the lowered position to the raised position.

The method may include one or more characteristics or features of the assembly and chassis as hereinbefore described.

The pivoting may include activating the actuating mechanism associated with the assembly to pivot the at least one guard rail to the raised or lowered position relative to the chassis.

In some embodiments, the method may further include securing the at least one guide rail relative to the chassis when the at least one guard rail is in the raised position. The securing may include securing the one or more retention pins or bolts of the slide mount to the guide rail to secure the guard rail relative to the chassis.

According to an eighth aspect of the present invention, there is provided a method of erecting a guard rail on a chassis of a vehicle, said method including:
fitting a guard rail assembly according to a fifth or a sixth aspect of the present invention to the chassis of the vehicle; and
raising the two or more support members and the at least one guard rail relative to the chassis to the operable position.

The method may include one or more characteristics or features of the assembly and chassis as hereinbefore described.

The raising may include activating the actuating mechanism to pivot the pivot arm associated with one of the two or more support members and thus raise the two or more support members and the at least one guard rail relative to the chassis to the operable position.

Any of the features described herein can be combined in any combination with any one or more of the other features described herein within the scope of the invention.

The reference to any prior art in this specification is not and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows;

FIG. 1 is an upper perspective view of a guard rail assembly according to a first embodiment of the present invention fitted to a chassis of a vehicle and shown in the raised position;

FIG. 2 is an upper perspective view of the guard rail assembly shown in FIG. 1 in the lowered position;

FIG. 3 is a sectional side view of the guard rail assembly as shown in FIG. 1; and

FIG. 4 is a sectional side view of the guard rail assembly as shown in FIG. 2;

FIG. 5 is a lower perspective view of a guard rail assembly according to a second embodiment of the present invention and shown in the raised position;

FIG. 6 is a lower perspective view of the guard rail assembly shown in FIG. 5 in the lowered position;

FIG. 7 is an upper perspective view of the guard rail assembly as shown in FIGS. 5 and 6 fitted to a chassis of a vehicle;

FIG. 8 is an upper perspective view of a guard rail assembly according to a third embodiment of the present invention fitted to a chassis of a vehicle and shown in an operable position;

FIG. 9 is an upper perspective view of the guard rail assembly shown in FIG. 8 in a folded position;

FIG. 10 is a side view of the guard rail assembly shown in FIGS. 8 and 9 in the operable position;

FIG. 11 is another side view of the guard rail assembly shown in FIG. 10 in the folded position; and

FIG. 12 is a side view of a guard rail assembly according to a fourth embodiment of the present invention.

### DETAILED DESCRIPTION

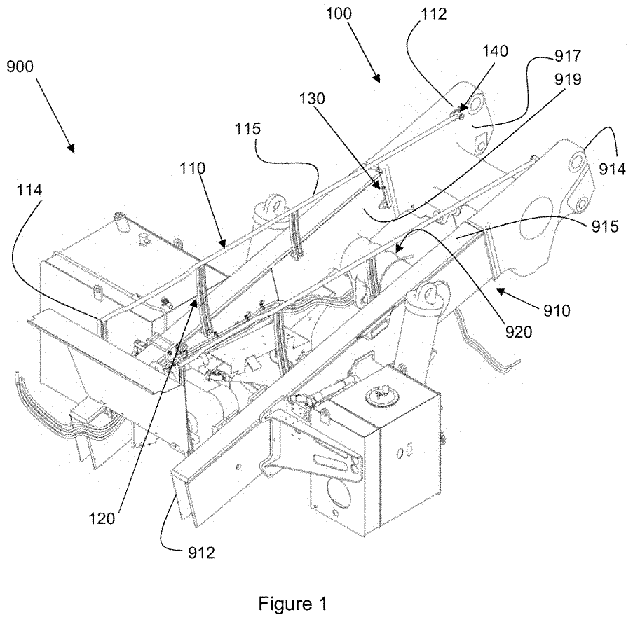

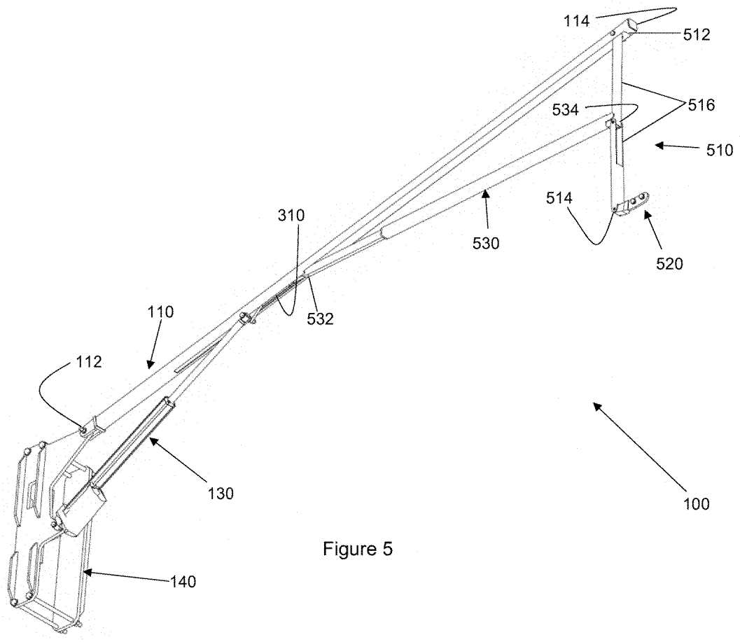

FIGS. 1 to 12 show a guard rail assembly (100) according to embodiments of the present invention fitted to a chassis (900; not shown in FIGS. 5, 6 and 10 to 12) of a rigid dump truck.

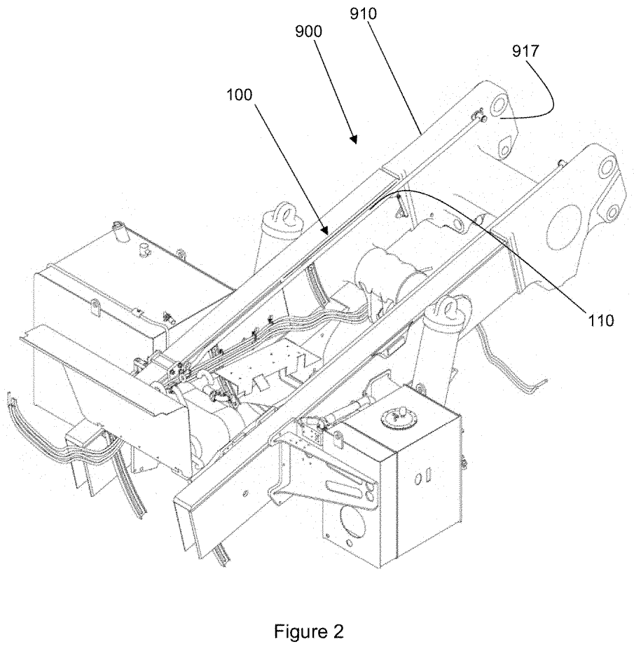

FIGS. 1 to 4 show a first embodiment of the guard rail assembly (100) with FIG. and 3 showing the assembly (100) in the raised position and FIGS. 2 and 4 showing the assembly (100) in the lowered position.

Referring to FIG. 1, the assembly (100) includes a guard rail (110) having a first end (112) pivotally mountable to the chassis (900) and a second end (114) pivotable relative to the chassis (900) between a lowered position (show in FIG. 2) and a shown raised position.

The assembly (100) includes three guide rails (120) for guiding and supporting movement of the guard rail (110) relative to the chassis (900). Each guide rail (120) extends downwards from the guard rail (110) and is slidably mountable to the chassis (900) for movement relative thereto.

The assembly (100) further includes an actuating mechanism in the form of a linear actuator (130) for driving movement the guard rail (110) between the raised and lowered positions.

The chassis (900) is a chassis of a rigid dump truck, a Komatsu™ HD1500 in particular.

The chassis (900) is formed from metal and includes a pair of longitudinally extending side frame members (910) joined together by a plurality of transversely extending cross frame members (920). The frame members (910, 920) are of tubular construction and are joined together using conventional welding techniques.

Each side frame member (910) includes a forward end (912) and an opposed rear end (914). The frame member (910) extends rearwardly at an angle such that the rear end (914) is elevated relative to the forward end (912).

Each side frame member (910) includes an upper wall (915), an opposed lower wall and a pair of opposed side walls extending longitudinally between the forward and rear ends (912, 914). The opposed side walls include an inner side wall (917) and an opposed outer side wall. Each side frame member (910) further includes an inner upper edge (919) between the inner side wall (917) and the upper wall (915).

The guard rail (110) has a substantially circular cross section and includes at least one side wall (115) extending longitudinally between the first and second ends (112, 114) in a linear direction. The guard rail (110) is of tubular construction and made of steel.

The guard rail (110) extends forward (i.e., towards the front end of the chassis (900)) from the first end (112) to the second end (114). As shown, the guard rail (110) is of a suitable length to extend at least partially along a length of the chassis (900) that may pose a fall hazard.

The first end (112) of the guard rail (110) is pivotally mounted to the inner side wall (917) of a side frame member (910) of the chassis (900) at a location at or near the rear end (914) and the inner upper edge (919). The first end (112) of the guard rail (110) is pivotally mounted via a guard rail mount (140)

The first end (112) of the guard rail (110) includes a HDPE bushing.

The guard rail mount (140) includes a bracket connectable to the inner side wall (917) of a side frame member (910) of the chassis (900) and a pivot pin for pinning the HDPE bushing at the first end (112) of the guard rail (100) to the bracket.

The bracket is connectable to the inner side wall (917) of the side frame member (910) with one or more mechanical fasteners and/or using conventional welding techniques.

In use, when the guard rail (110) is in the raised position as shown, the second end (114) of the guard rail (110) pivots upwards relative to the chassis (900) such that the guard rail (110) functions as a barrier to prevent a worker from falling over the inner upper edge (919) of a longitudinally extending side frame member (910) of the chassis (900) to which it is pivotally mounted.

The second end (114) of the guard rail (110) pivots to a height of about 1,127 mm above the chassis (900) when in the raised position.

Likewise, the guard rail (110) pivots to about an angle of about 13° relative to the side frame member (910) of the chassis (900) to which it is mounted when in the raised position, preferably such that the guard rail (110) has a substantially horizontal orientation.

Conversely, and briefly referring to FIG. 2, when the guard rail (110) is in the lowered position the guard rail (110) extends at least partially along the inner side wall (917) of the longitudinally extending side frame member (910) of the chassis (900) to which it is pivotally mounted in a substantially parallel arrangement. Advantageously, in the lowered position the guard rail (110) does not interfere with any normal operations of the vehicle thereby allowing the guard rail assembly (100) of the present invention to remain permanently fitted to the chassis (900) of the vehicle for subsequent use.

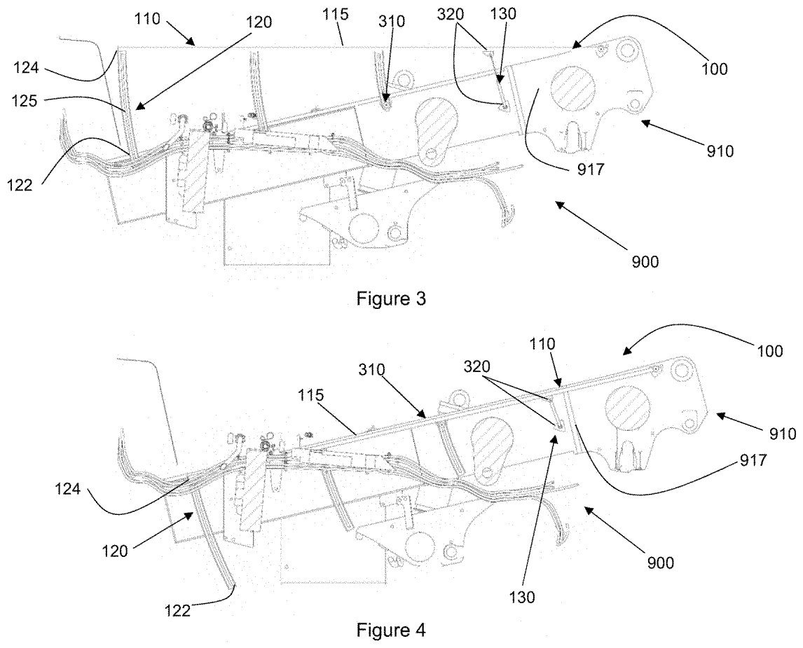

Referring to FIGS. 3 and 4, the three guide rails (120) guide and support movement of the guard rail (110) relative to the chassis (900).

Each guide rail (120) has an elongate structure extending longitudinally between a pair of opposed ends, including a chassis connecting end (122) and a guard rail connecting end (124). Each guide rail (120) is made of steel and extends longitudinally in an arc between the opposed ends (122, 124).

Each guide rail (120) extends downwards from the guard rail (110) and is slidably mounted to the inner side wall (917) of a longitudinally extending side frame member (910) of the chassis (900) via a slide mount (310).

Each guide rail (120) is joined to the guard rail (110) using conventional welding techniques.

Referring to FIG. 3, each guide rail (120) includes a groove (125) extending longitudinally between the opposed ends (122, 124) and the chassis (900) includes the slide mount (310) connectable to the inner side wall (917) of a side frame member (910) of the chassis (900) and configured to be slidable within and along a length of the groove (125) of the guide rail (120).

The slide mount (310) include a bracket connectable to the inner side wall (917), a shank extending away from the bracket and configured to have the groove (125) of the guide rail (120) mounted thereon, and a fastener for securing the guide rail (120) relative to the slide mount (310).

The bracket is connectable to the inner side wall (917) of the side frame member (910) of the chassis (900) with one or more mechanical fasteners and/or using conventional welding techniques.

The fastener of the slide mount (310) includes a nut, and the shank includes at least a threaded outer portion for the fastener to be threadingly fastened thereto.

The slide mount (310) further includes a HDPE washer.

As shown, the guide rails (120) are evenly spaced along a length of the guard rail (110) and are of differing lengths thereby providing respective grooves (125) with differing travel lengths, since the guard rail (110) pivots about the first end (112).

Referring again to FIGS. 3 and 4, the linear actuator (130) extends between the side frame member (910) of the chassis (900) and the guard rail (110) and is capable of moving between an extended position shown in FIG. 3 and a retracted position shown in FIG. 4. The extended and retracted positions correspond with the raised and lowered positions of the guard rail (110) relative to the chassis (900), respectively.

The linear actuator (130) comprises a pneumatic ram and is pivotally coupled to each of the guard rail (110) and the inner side wall (917) of a side frame member (910) of the chassis (900) by mounting brackets (320) respectively located on each.

The mounting brackets (320) are respectively connectable to the side wall (115) of the guard rail (110) and the inner side wall (917) of the side frame member (910) of the chassis (900) with one or more mechanical fasteners and/or using conventional welding techniques.

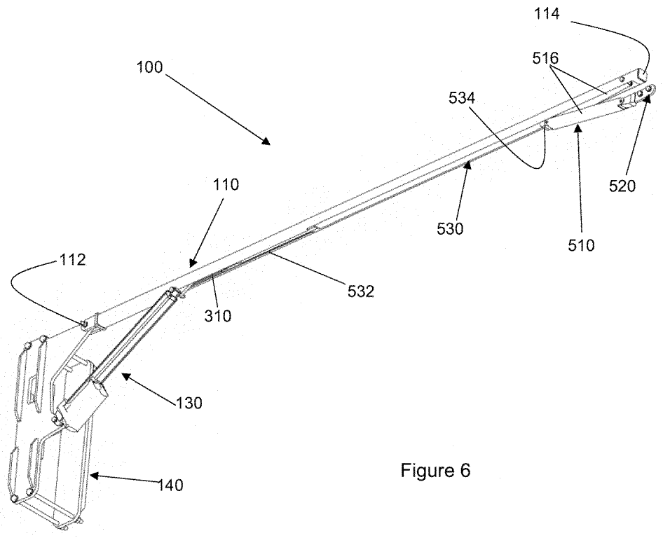

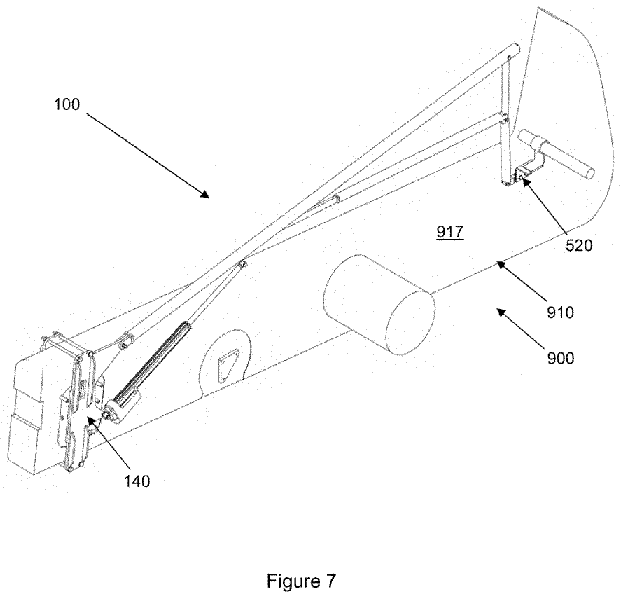

FIGS. 5 to 7 show a second embodiment of the guard rail assembly (100) with FIGS. 5 and 7 showing the assembly (100) in the raised position and FIG. 6 showing the assembly (100) in the lowered position. For convenience, features that are similar or correspond to features of the first embodiment will be referenced with the same reference numerals.

Referring to FIG. 5, the assembly (100) includes a guard rail (110) having a first end (112) pivotally mountable to a chassis (900; not visible) via a guard rail mount (140) and a second end (114) pivotable relative to the chassis (900; not visible) between a raised position as shown and a lowered position as shown in FIG. 6.

The assembly (100) includes a support member (510) for moving the guard rail (110) relative to the chassis (900; not shown).

The support member (510) has a first end (512) pivotally mountable to the guard rail (110) at or near the second end (114) and a second end (514) pivotally mountable to the chassis (900; not visible) via a support member mount (520).

The support member (510) is pivotable about the second end (514) between a folded position, as shown in FIG. 6, relative to the chassis (900; not visible) in which the guard rail (110) is in the lowered position and an extended position as shown in which the support member (510) is in a substantially upright position and the guard rail (110) is in the raised position.

The assembly (100) further includes a sliding member (530) for moving the support member (510) between the folded and extended positions and thereby moving the guard rail (110) relative to the chassis (900; not visible).

The sliding member (530) has a first end (532) slidably mounted to the guard rail (110) and an opposed second end (534) pivotally connected to the support member (510).

The sliding member (530) at the first end (532) is connected to an actuating mechanism in the form of a linear actuator (130) for driving movement of the sliding member (530) at least partially along the guard rail (110) so as to cause the support member (510) to pivot between the folded and extended positions and the guard rail (110) to thereby pivot between the lowered and raised positions, respectively.

In this embodiment, the guard rail (110) defines an inverted U-shaped groove extending at least partially between the opposed ends (112, 114) and the first end (532 of the sliding member (530) includes a slide mount (310) connectable to the guard rail (110) and configured to be slidable within and along a length of the inverted U-shaped groove.

Referring briefly to FIG. 6, the support member (510) is formed from two member portions (516) pivotally coupled together and foldable relative to each other alongside the chassis (900; not visible) when in the folded position.

The sliding member (530) is pivotally coupled at the second end (534) to a lower end of an uppermost member portion (516) so as to cause the portions (516) to fold relative to one another when the sliding member (530) slides at least partially along the guard rail (110) towards the first end (112).

Conversely and with reference to FIG. 5, when the sliding member (530) slides at least partially along the guard rail (110) towards the second end (114), the sliding member (530) causes the portions (516) to unfold, the lowermost portion (516) to pivot upwards and the portions (516) to align in an end-to-end arrangement in the extended position (and thereby pivot the second end (114) of the guard rail (110) to the raised position).

Referring to FIG. 7, the guard rail assembly (100) of this embodiment, like the first embodiment, is mounted to the inner sidewall (917) of the side frame member (910) of the chassis (900) via the guard rail mount (140) and the support member mount (520).

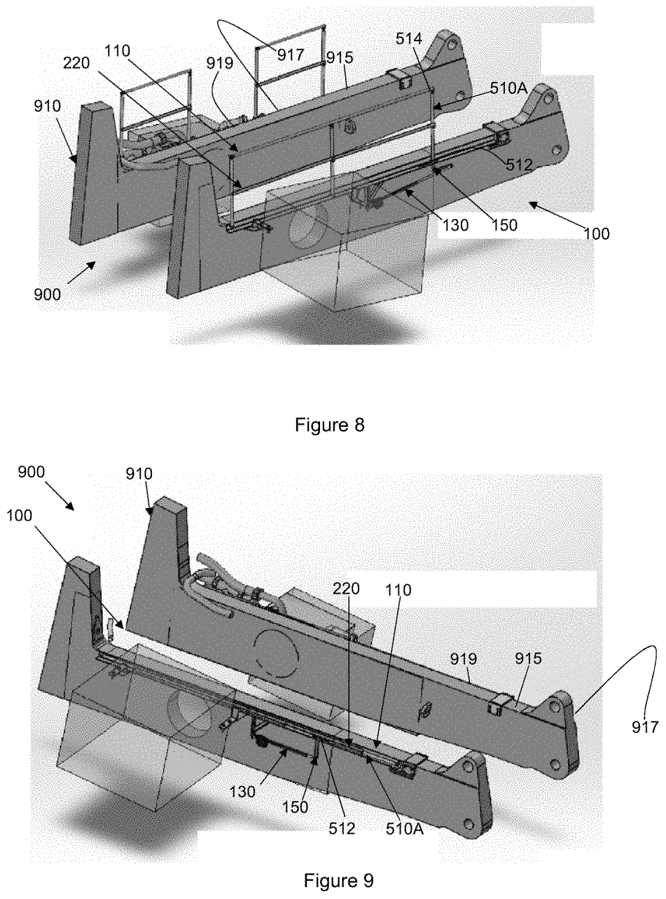

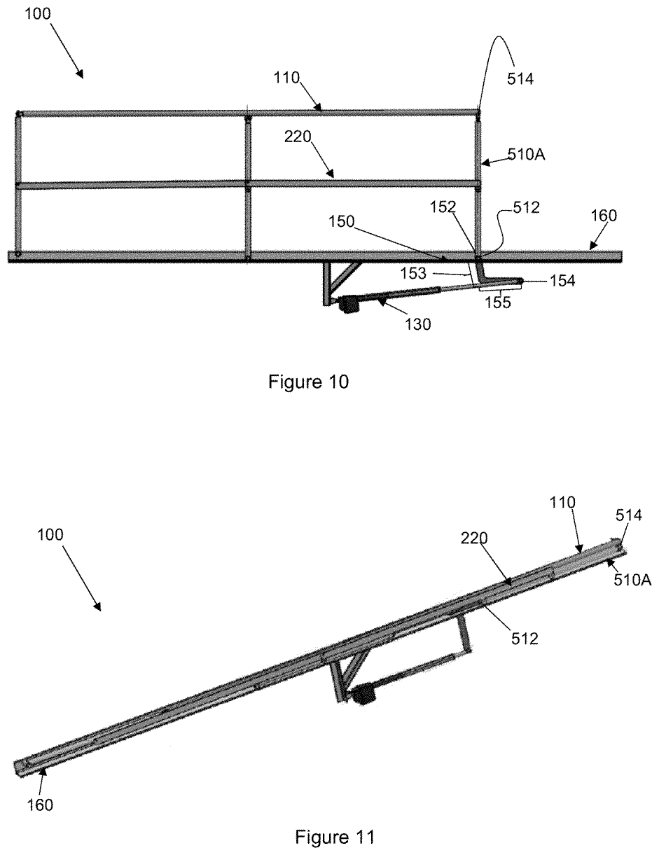

FIGS. 8 to 11 show a third embodiment of the guard rail assembly (100) with FIGS. 8 and 10 showing the assembly (100) in the raised position and FIGS. 9 and 11 showing the assembly (100) in the lowered position. For convenience, features that are similar or correspond to features of the first embodiment will be referenced with the same reference numerals.

Referring to FIG. 8, the assembly (100) includes an upper guard rail (110) and lower guard rail (220); and a plurality of support members (510) for supporting the guard rails (110, 220) relative to the chassis (900).

Each of the support members (510) includes a lower end (512) pivotally mountable to the chassis (900) and the guard rails (110, 220) are pivotally coupled to the support members (510). Specifically, each of the support members (510) is pivotally coupled to an outer side wall (917) of the side frame members (910) of the chassis (900).

The assembly (100) further includes an actuating mechanism in the form of a linear actuator (130) for raising and lowering the support members (510) and guard rails (110, 220) relative to the chassis (900) between the shown operable position in which the support members (510) stand proud atop the chassis (900) and a folded position, as shown in FIG. 9, in which the support members (510) and guard rails (110, 220) are folded relative to the chassis (900).

As shown in both FIGS. 8 and 9, the assembly (100) further includes a pivot arm (150) extending from a lower end (512) of one of the support members (510A) for interconnecting the support member (510A) with the linear actuator (130).

Referring to FIG. 10, the upper and lower guard rails (110, 220) each have a substantially circular cross section and include at least one sidewall extending longitudinally between opposed ends in linear direction. Each guard rail (110, 220) is of tubular construction and made of steel.

As shown, the guard rails (110, 220) are both supported relative to the chassis (900; not shown) by the support members (510) and moveable relative to the chassis (900; not shown) between the operable and folded positions in a substantially parallel arrangement relative to the chassis (900; not shown).

Like the guard rails (110, 220), the support members (510) each have a substantially circular cross section and include at least one sidewall extending longitudinally between opposed ends in linear direction. The opposed ends include a lower end (512) and an opposed upper end (514). Each support member (510) is of tubular construction and made of steel.

As indicated, the guard rail (110, 220) are pivotally coupled to the support members (510) such that upper and lower guard rail (110, 130) spans between an adjacent pair of support members (510).

The upper guard rail (110) and the upper ends (514) of the support members (510) are pivotally coupled together by intermeshing lugs each having a central bore therethrough and configured to be pinned together by at least one pivot pin received through the co-aligned central bores.

The lower guard rail (220) also includes a lug having a central bore therethrough at each end, which is pinned to a side of an adjacent support member (510) with at least one pivot pin.

The support members (510) are pivotally mounted at their lower ends (512) to the chassis (900; not shown) via a chassis mount (160) configured to be fastened along an outer upper edge (919; not shown) of a side frame member (910; not shown) of the chassis (900; not shown).

Each support member (510) is pivotable about the lower end (512) such that the upper end (514) is pivotable between the operable and folded positions relative to the chassis (900; not shown), as shown in FIGS. 10 and 11, respectively.

The upper end (514) of each support member (510) is able to pivot about a range of movement about 90° from a substantially vertical orientation when in the operable position.

The lower end (512) of each support member (510) includes a bore defined thereon and configured to receive a pivot pin therethrough for pivoting the lower end (512) to a rail of the chassis mount (160).

As shown, the assembly (100) includes a linear actuator (130) for raising and lowering the support members (510) and the guard rails (110, 220) relative to the chassis (900; not shown).

A pivot arm (150) extends downwardly from the lower end (512) of one of the support members (510A) for interconnecting with the linear actuator (130).

The pivot arm (150) includes a proximal end (152) fixedly connected to the lower end (512) of the support member (510A) and an opposed distal end (154) configured to be pivotally coupled to the linear actuator (130).

The pivot arm (150) has an L-shaped elongate body and includes a proximal end portion (153) and a distal end portion (155) orthogonally arranged relative to the proximal end portion (153).

The pivot arm (150) extends downwardly from the lower end (512) of the support member (510) and alongside a rail of the chassis mount (160).

In use, the pivot arm (150) pivots about the proximal end (152) together with the support member (510A) and the distal end (154) pivots towards and away from the linear actuator (130) to raise and lower the support member (510A) (and the remaining support members (510) mechanically linked to the support member (510A) via the guard rails (110, 220)) between the operable and folded positions.

As shown, the linear actuator (130) is pivotally coupled at a first end to a bracket extend downwardly from the chassis mount (160) and at an opposed second end to the distal end (154) of the pivot arm (150).

With reference to FIG. 10, when the linear actuator (130) is extended, the distal end (154) of the pivot arm (150) is pivoted away from the linear actuator (130) and the support member (510A) (and the remaining support members (510) mechanically linked to the support member (510A) via the guard rails (110, 220)) is pivoted to the operable position.

With reference to FIG. 11, when the linear actuator (130) is retracted, the distal end (154) of the pivot arm (150) is pivoted towards the linear actuator (130) and the support member (510A) (and the remaining support members (510) mechanically linked to the support member (510A) via the guard rails (110, 220)) is pivoted to the folded position.

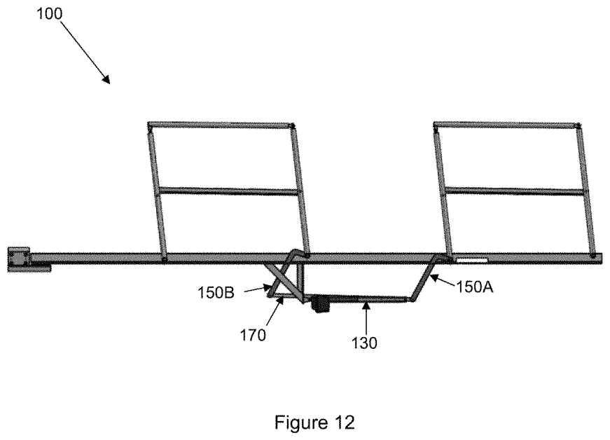

FIG. 12 shows a fourth embodiment of the foldable guard rail assembly (100). For convenience, features that are similar or correspond to features of the first embodiment will be referenced with the same reference numerals.

In this embodiment, the assembly (100) includes two pivot arms (150) mechanically linked together by a bar (170) so that movement of one pivot arm (150A) by an associated linear actuator (130) drives movement of the other pivot arm (150B). Advantageously, such arrangements facilitate synchronized movement of two or more discrete guard rails (100).

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A guard rail assembly for a chassis of a vehicle, said assembly comprising:
at least one guard rail;
two or more support members for supporting the at least one guard rail relative to the chassis, each of said support members having an upper end pivotally coupled to the at least one guard rail and an opposed lower end pivotally mountable to the chassis;
an actuating mechanism for raising and lowering the two or more support members and the at least one guard rail relative to the chassis between a folded position in which the two or more support members and the at least one guard rail are folded relative to the chassis and an operable position in which the two or more support members extend proud from the chassis with the at least one guard rail extending therebetween; and
a pivot arm extending from a lower end of at least one of the support members for interconnecting the support member with the actuating mechanism.

2. The guard rail assembly of claim 1, wherein the at least one guard rail comprises two guard rails supported relative to the chassis by the two or more support members.

3. The guard rail assembly of claim 2, wherein the two guard rails comprise a top guard rail pivotally coupled to the upper end of each of the two or more support members and a lower guard rail pivotally coupled about midway along a length of each of the two or more support members.

4. The guard rail assembly of claim 1, wherein the two or more support members are pivotally mounted at their respective lower ends to the chassis so as to be pivotable about their lower ends and such that the respective upper ends are pivotable between the folded and operable positions.

5. The guard rail assembly of claim 4, wherein the upper end of each support member is pivotable about a range of movement of about 90° between the folded and operable positions.

6. The guard rail assembly of claim 1, wherein the lower end of each support member comprises a bore defined thereon and configured to receive a pivot pin therethrough for pivoting the lower end relative to the chassis.

7. The guard rail assembly of claim 1, wherein the actuating mechanism comprises one or more linear actuators.

8. The guard rail assembly of claim 1, wherein the pivot arm comprises a pair of opposed ends and an elongate body extending therebetween in an angled orientation.

9. The guard rail assembly of claim 8, wherein the opposed ends comprise a proximal end fixedly connected to the lower end of the at least one of the support members and an opposed distal end configured to interconnect with the actuating mechanism.

10. The guard rail assembly of claim 9, wherein the pivot arm is arranged in an offset arrangement with the lower end of the at least one of the support members so that it may extend alongside the chassis.

11. The guard rail assembly of claim 9, wherein the pivot arm extends through an elongate opening defined in a rail of the chassis.

12. The guard rail assembly of claim 9, wherein, in use, the pivot arm pivots about the proximal end together with the at least one of the support members and the distal end is pivoted towards and away from the actuating mechanism to raise and lower the support members and the at least one guard rail between the folded and operable positions.

13. The guard rail assembly of claim 12, wherein the actuating mechanism comprises a linear actuator located beneath the assembly and configured to move between extended and retracted positions to pivot the pivot arm and thus the at least one of the support members and the at least one guard rail between the folded and operable positions.

14. The guard rail assembly of claim 13, wherein the linear actuator is pivotally coupled to each of the pivot arm and an outer side wall of a longitudinally extending side frame of the chassis, or a rail mounted thereon, by a mounting bracket located thereon.

15. The guard rail assembly of claim 1, wherein the pivot arm comprises two or more pivot arms mechanically linked together so that movement of a first said pivot arm by an associated said actuating mechanism drives movement of other said pivot arms thereby synchronizing movement of two or more discrete said guard rails.

16. The guard rail assembly of claim 1, further comprising a chassis mount for mounting the assembly to an outer upper edge of a longitudinally extending side frame of the chassis.

17. The guard rail assembly of claim 16, wherein the chassis mount comprises an edge rail configured to fit over the outer upper edge and one or more mounting brackets for mounting the edge rail to the outer upper edge of the chassis.

18. The guard rail assembly of claim 17, wherein the two or more support members are pivotally mounted to the edge rail.

19. A method of erecting a guard rail on a chassis of a vehicle, said method comprising:
fitting a guard rail assembly according to claim 1 to the chassis of the vehicle; and
raising the two or more support members and the at least one guard rail relative to the chassis to the operable position.

20. The method of claim 19, wherein the raising comprises activating the actuating mechanism to pivot the pivot arm associated with one of the two or more support members to thus raise the two or more support member and the at least one guard rail relative to the chassis to the operable position.
